(19) United States
(12) Patent Application Publication
(10) Pub. No.: US 2006/0280351 A1
(43) Pub. Date: Dec. 14, 2006

(54) Systems and methods for automated measurements and visualization using knowledge structure mapping ("knowledge structure mapping")

(75) Inventors: Zhou Luping, (US); Wang Yapeng, (US); Goh Lin Chia, (US)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, s.p.a, Milano (IT)

(21) Appl. No.: 11/289,230

(22) Filed: Nov. 28, 2005

Related U.S. Application Data
(60) Provisional application No. 60/631,266, filed on Nov. 26, 2004.

(51) Int. Cl. G06K 9/00

(52) U.S. Cl. 382/128

(57) ABSTRACT

Various methods for automatically generating a structured clinical report by using a pre-defined template structure and mapping it to the imaging data set of an organ (such as a CT or MR scan) are presented. A template or knowledge structure may describe the general structure of a tube-like organ, and may be based on prior knowledge related to acceptable ranges of measurement or rations for a particular organ or area of interest. The organ of interest may be segmented out from original image slices. In exemplary embodiments of the present invention a corresponding centerline can be calculated and a skeleton of the tube-like organ can be created. Based on the centerline extracted, a knowledge structure (template) can be mapped to the organ data. Since required measurements may be defined in the template, actual measurements can be automatically calculated for the structure. Such measurements may be further refined in a three dimensional environment, and can be used to form a structured clinical report for further use.

### CROSS-REFERENCE TO RELATED APPLICATIONS

This application claims the benefit of U.S. Provisional Patent Application No. 60/631,266, filed on Nov. 26, 2004, the disclosure of which is hereby incorporated herein by this reference as if fully set forth.

### FIELD OF THE INVENTION

This invention relates to the field of medical imaging, and more precisely to various methods for measuring parameters of and interactively visualizing anatomical structures which can be mapped to a template using knowledge structure mapping.

### BACKGROUND OF THE INVENTION

By exploiting advances in technology, medical procedure planning and diagnostics can be performed in a virtual environment. With the advent of sophisticated diagnostic scan modalities such as, for example, Computerized Tomography (“CT”), a radiological process wherein numerous X-ray slices of a region of the body are obtained, substantial data can be obtained on a given patient so as to allow for the construction of a three-dimensional volumetric data set representing the various structures in a given area of a patient's body subject to the scan. Such a three-dimensional volumetric data set can be displayed using known volume rendering techniques to allow a user to view any point within such three-dimensional volumetric data set from an arbitrary point of view in a variety of ways.

One area where this phenomenon has occurred has been in the examination of tube-like internal body structures such as the aorta, colon, etc. for procedural planning purposes. Conventional methods measure the vascular diameters in the acquired 2D slices. However, the orientation of these slices is not necessarily orthogonal to the tube-like structure under measurement. This limitation causes inaccurate diameter and length measurements.

For different surgical planning procedures, there are corresponding sets of anatomical considerations. Given the number of different procedures and anatomical considerations, a structured clinical report is needed in order to control the number and the location of measurements adapted to different purposes. However, most current software in this field either measure the structure manually or measure a point in the structure automatically but leave users to decide where to measure. Thus, doctors or other users have to remember all the parameters they need for different cases. Therefore, there are at least two drawbacks to present systems: (1) users make redundant measurements; or (2) users make insufficient measurements. Furthermore, in order to obtain a complete clinical report, users have to perform intensive interactions.

Thus, what is needed are automatic measurement and display systems for anatomical structures which utilize templates for different organs or areas of interest. Applied, for example, to the area of stenting of abdominal aortic aneurysms, what is needed in the art are techniques and display modes which provide automated measurements and visualization of abdominal aortic aneurysms and structure mappings.

### SUMMARY OF THE INVENTION

Various methods for automatically generating a structured clinical report by using a pre-defined template structure and mapping it to the imaging data set of an organ (such as a CT or MR scan) are presented. A template or knowledge structure may describe the general structure of an organ, such as for example, a tube-like organ, and may be based on prior knowledge related to acceptable ranges of measurement or rations for a particular organ or area of interest. The organ of interest may be segmented out from original image slices. In exemplary embodiments of the present invention a corresponding centerline can be calculated and a skeleton of a tube-like organ can be created. Based on the centerline extracted, a knowledge structure (template) can be mapped to the organ data. Since required measurements may be defined in the template, actual measurements can be automatically calculated for the structure. Such measurements may be further refined in a three dimensional environment, and can be used to form a structured clinical report for further use.

### BRIEF DESCRIPTION OF THE DRAWINGS

FIG. 1 depicts exemplary process flow for measuring abdominal aortic aneurysms using knowledge structure mapping according to an exemplary embodiment of the present invention;

FIG. 2 depicts an exemplary measurement template for abdominal aortic aneurysm planning procedures according to an exemplary embodiment of the present invention;

FIG. 3 details the steps of centerline extraction of step 105 of FIG. 1 according to an exemplary embodiment of the present invention;

FIG. 4 illustrates further detail of the steps for classification of border points that are components of step 320 illustrated in FIG. 3 according to an exemplary embodiment of the present invention;

FIG. 5 depicts further detail of the check for simple points that is illustrated in step 340 of FIG. 3 according to an exemplary embodiment of the present invention;

FIG. 6 illustrates a detailed smoothing method for smoothing step 106 in FIG. 1 according to an exemplary embodiment of the present invention;

FIGS. 7 and 8 show an alternative two-step smoothing method according to an exemplary embodiment of the present invention;

FIG. 9 shows a detailed ellipse mapping method for step 107 of FIG. 1 according to an exemplary embodiment of the present invention;

FIG. 10 illustrates the results of a seed-based region growing method with edge detection according to an exemplary embodiment of the present invention;

FIG. 11 depicts ellipse mapping results according to an exemplary embodiment of the present invention;

FIG. 12 shows detailed steps of the template mapping step 108 of FIG. 1 according to an exemplary embodiment of the present invention;

FIG. 13 illustrates template mapping results of an abdominal aorta and iliac arteries according to an exemplary embodiment of the present invention;

FIG. 14 illustrates automated detection results of aorta and iliac bifurcations according to an exemplary embodiment of the present invention;

FIG. 15 illustrates detailed steps of the edit measurements step 109 of FIG. 1 according to an exemplary embodiment of the present invention;

FIG. 16 shows a 3D editing interface according to an exemplary embodiment of the present invention;

FIG. 17A illustrates the diameter of an ellipse prior to a move procedure according to an exemplary embodiment of the present invention;

FIG. 17B depicts the diameter of an ellipse after being moved according to an exemplary embodiment of the present invention;

FIG. 18A shows an ellipse diameter prior to a resizing procedure according to an exemplary embodiment of the present invention;

FIG. 18B depicts a resized diameter of an ellipse according to an exemplary embodiment of the present invention;

FIGS. 19A and 19B illustrate the diameter of an ellipse before shaping and after shaping according to an exemplary embodiment of the present invention;

FIG. 20A illustrates and ellipse prior to a rotation procedure, and FIG. 20B depicts the ellipse after rotation according to an exemplary embodiment of the present invention;

FIG. 21 shows editing angular measurements according to an exemplary embodiment of the present invention;

FIG. 22 depicts freehand validation of measurements according to an exemplary embodiment of the present invention; and

FIG. 23 illustrates a guided validation with a slice view according to an exemplary embodiment of the present invention.

It is noted that the patent or application file contains at least one drawing executed in color. Copies of this patent or patent application publication with color drawings will be provided by the U.S. Patent Office upon request and payment of the necessary fees.

It is also noted that some readers may only have available greyscale versions of the drawings. Accordingly, in order to describe the original context as fully as possible, references to colors in the drawings will be provided with additional description to indicate what element or structure is being described.

### DETAILED DESCRIPTION OF THE INVENTION

Various methods and systems are provided for automatically generating a structured clinical report by mapping a pre-defined knowledge structure to organ data. Such methods and systems perform necessary measurements and greatly reduce the amount of user interactions. In exemplary embodiments of the present invention, a template (i.e., a knowledge structure) that describes the general structure of the tube-like organ can be defined based on prior knowledge of acceptable range and ratios of measurements amongst measurement nodes. Measurement nodes are nodes in the knowledge structure where the point and types of measurement are defined. For example, a point can be specified at the start of the knowledge structure, which will measure the maximum and minimum diameters at that point or an angular measurement can be defined for any three points in the knowledge structure. In exemplary embodiments of the present invention, critical nodes in the knowledge structure can also be identified. Critical nodes are measurement nodes which contain additional measurement conditions. The measurement conditions can be affiliated with critical nodes are any supported measurements (such as, for example, lengths, areas, volumes, and angles) that can have a measurement condition. The specification in the critical node defines the passing condition for the measurements at that measurement point.

In exemplary embodiments of the present invention a user can, for example, define a desired section of the organ by putting points at the ends of the organ. In such exemplary embodiments, corresponding centerlines can be generated as a skeleton using the defined points. Based on the centerlines extracted, the knowledge structure (i.e., template) can be mapped to real organ data. Having the required measurement points for a given organ defined in the template may allow for the measurement process to be automated. These automated measurements can be used to form a structured clinical report for further use. In some exemplary embodiments, the measurements may be edited and refined in a three-dimensional environment, which may be displayed stereoscopically, using various stereoscopic display modes, or even autostereoscopically. In exemplary embodiments, those measurements that did not pass the condition specified in the critical nodes can be identified for users. Also, measurements that are outside of the acceptable range or ratio as specified by the template may be brought to the attention of the user.

In exemplary embodiments, the methods and systems may be used to measure an abdominal aortic aneurysm, and assist in appropriate stent selection. The measurements can be used to select the best fitting stent from a stent database, or for use in custom stent fabrication.

In exemplary embodiments of the present invention novel systems and methods are provided for measurement and visualization of organs with signature structures using knowledge structure mapping. These exemplary embodiments may be used, for example, in surgery planning. In what follows tube-like structures such as the abdominal aorta will be used to illustrate the methods of the present invention. However the methods and systems of the present invention equally apply to any anatomical structure with a structural signature that can be mapped to a knowledge structure or template.

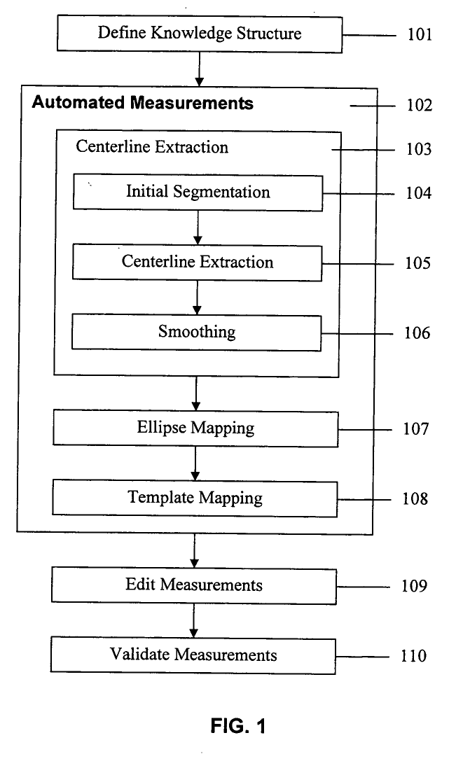

FIG. 1 illustrates an exemplary method for defining a knowledge structure, performing automated measurements, editing to further refine the measurements and measurement validation. In exemplary embodiments of the present invention, this method may be used for measurement and evaluation of abdominal aortic aneurysms. The steps of the method are described in detail below.

According to exemplary embodiments, structured clinical reports can be generated by using a pre-defined template structure. Such template structures can be a mathematical model that captures a known range of measurements or ratios of human anatomy. These can be mapped to the imaging data set of the tubular structure of interest (e.g., a human organ). In exemplary embodiments of the invention, an imaging data set can be acquired by using such imaging techniques as CT, MR, ultrasound, or any other suitable imaging technique. In some embodiments, these template structures may act as a validation tool to determine whether the acquired data from a scan is outside of an acceptable range or ratio. Such a validation procedure could be selected by a user or be performed automatically. An exemplary system could alert a user if the data is out of an acceptable range or ratio, and recommend that a new set of data needs to be obtained.

In one exemplary embodiment, three processing stages can be utilized for stent graft selection for abdominal aortic aneurysms. These processing stages can include, for example: (1) knowledge structure definition; (2) automated measurement (template mapping); (3) post-process measurement editing to refine the automated measurements; and (4) validation of measurements.

Knowledge Structure Definition

Defining the knowledge structure is initial step of the exemplary methodology depicted in 100 of FIG. 1. In exemplary embodiments of the present invention, several measurements and acceptable ranges of values may be considered during a stent planning procedure for abdominal aortic aneurysms. These measurements may be part of a knowledge structure to be used in the planning procedure. Such a knowledge structure can, for example, allow a planner to determine whether the scan data measurements are appropriate, or whether a new scan must be performed.

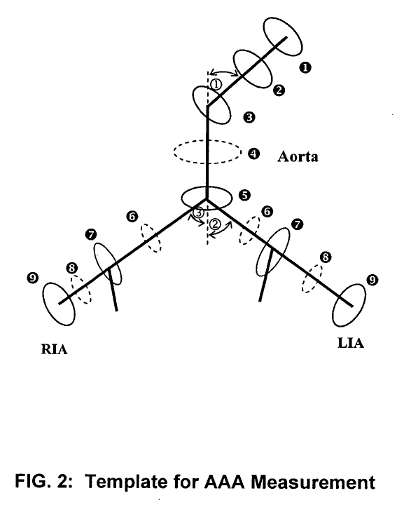

FIG. 2 illustrates exemplary measurement points for a template for use with abdominal aortic aneurysm cases and stent planning procedures. For this exemplary template, a patient typically should have a 1.5 to 2 cm neck of normal aorta below the renal arteries and above the aneurysm to provide a site for stable implantation of the graft to the arterial wall. The aortic neck should be approximately 26 mm or less in diameter and be free of thrombus. In addition, the angle that the aneurysm and aortic neck makes with normal aorta should generally be less than 60 degrees. The access arteries that are the external iliac and common iliac arteries must be larger enough to accept the devices. Therefore, their size should generally exceed 7 mm in diameter. However, if the external iliac are less than approximately 7 mm in diameter, a cut on the common iliac artery can be performed for carrier placement. The cut may allow for the diameter to be increased such as to allow for the carrier placement.

Again, referring to the template of FIG. 2, the common iliac arteries, which may be utilized as the “landing zone” for the graft limbs, should be approximately 13 mm or less in diameter. Furthermore, if the angulation of the common iliac arteries is excessive, it presents an impediment to the advancement of the stent graft carrier. In an exemplary system, a user would be alerted if this angulation is excessive. Moreover, the angle between longitudinal axis of the aorta and common iliac arteries should generally be less than 45 degrees in order for the deployment of a bifurcated endograft to be successful. Also, it should be noted that distal deployment sites up to 20 mm in diameter can typically be utilized, provided that reverse tapering of the iliac limb is achieved.

There are several measurements not depicted in FIG. 2 that may be useful in defining the knowledge structure for abdominal aortic aneurysms according to exemplary embodiments of the invention. For example, the length from the lower renal artery to the aortic bifurcation may be one such measurement. In addition, the length of the lower renal artery to the end of the left iliac artery, the length from the lower renal artery to the end of the right iliac artery, and the length of the aneurysm may also be useful in defining the knowledge structure.

In exemplary embodiments of the present invention, the volume of the aortic aneurysm can also be specified in the knowledge structure and measured. Some components in the template, such as the minimum diameters of the left and right common iliac arteries, the minimum diameters of the left and right external iliac artery, the length of aortic neck, and the left and right iliac artery angles, may determine whether a patient can undergo stent implantation or not. These measurement points may be identified as critical nodes, where each critical node has a related conditional test. For example, the conditional test for the minimum diameter of common iliac arteries is whether the diameter is more than 7 mm. These conditional tests will be used to determine suitability of stent implantation and be used for the search for the best fitting stent. In some exemplary embodiments, there can be more than one test affiliated with a critical node in order to account for situations in which more than one test may need to be performed. For example, the diameter of the common iliac artery should typically be in the range of 7 mm to 13 mm and the angle it subtends with, the longitudinal axis of the aorta, should be less than 45 degrees.

Automated Measurements

Turning again to FIG. 1, 102 details the exemplary method or the present invention for automated measurement. This can include, for example, the centerline extraction of 103, along with the ellipse mapping of 107 and the template mapping of 108. An automated measurements process may provide measurements for endovascular repair of abdominal aortic aneurysms. This automated measurements process may use tomographic images as input, along with four user-defined points: one above the renal artery, one just below the lower renal artery, one at the end of left external iliac artery and one at the end of right external iliac artery. Using these inputs, the lengths, diameters, angles, and volumes used for stent planning can, for example, be produced.

In exemplary embodiments of the present invention, the abdominal aortic aneurysm can be segmented out from the original tomographic image slices, and then the centerline of the part of interest can be extracted. Based on the centerline, vascular diameters, lengths and angles are computed. The biggest part of the aneurysm, the aortic bifurcation, and the smallest parts of the common and external iliac arteries are automatically detected as well.

Using the tomographic scan data (e.g., CT or MR image data) that has been acquired, a volume may be rendered and an image can be displayed. In exemplary embodiments of the present invention, the displayed image may be a stereoscopic or autostereoscopic. In order to facilitate the automatic measurement of the area of interest for the abdominal aortic aneurysm stent planning procedure, four points may be inputted by the user: one above the renal artery, one just below the lower renal artery, one at the end of left external iliac artery, and one at the end of right external iliac artery. After the user has selected these four points, the exemplary system can automatically measure the necessary lengths. Automated measurement of the diameters of the abdominal aorta, as well as the left and right iliac arteries, and the angles between them may occur. These resulting measurements may be used to determine the appropriate stent for the endovascular repair for an abdominal aortic aneurysm.

103 of FIG. 1 illustrates the overall centerline extraction process, which includes initial segmentation 104, centerline extraction 105, and smoothing 106. Centerline extraction 103 can, for example, utilize tomographic slices and three user-defined points to extract the centerline of an aneurysm, which may become the basis for further measurements.

At initial segmentation 104, based on the intensities of the four user-defined points, an adaptive threshold can be determined and used as the input parameter to the algorithm to segment the aorta. The maximum and the minimum intensities of the four points are used to determine the threshold. Given the minimum and maximum intensity values, a domain-specific value can be added or deducted to produce a threshold range. For example, if the minimum and maximum intensity values of the four points are 75 and 120, respectively, the domain specific value of 15 may be added or deducted from these values to obtain an exemplary adaptive threshold range of 60-135.

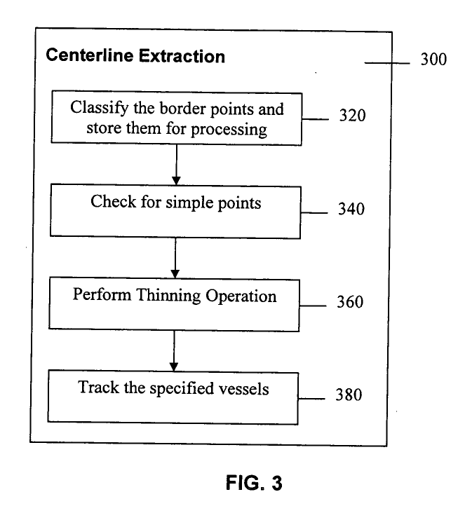

The centerline extraction 105 of FIG. 1 is provided in further detail in FIG. 3. For the centerline generation, a thinning algorithm derives the skeleton of the segmented aorta. In exemplary embodiments, a 26-way parallel thinning method is implemented. In order to ensure that the centerline is accurately positioned at the center of the segmented data, the algorithm can remove the voxels symmetrically in 3D. In alternative embodiments, the exemplary method may check the voxels using 6-way, 18-way and 26-way point connectivity. In some instances there may be some unexpected branching, since thinning methods are generally very sensitive to surface smoothness and noise. For example, a single voxel “bump” or a “hole” on the surface can result in a branch that deviates from the main centerline.

With the predefined three vessel voxel points, the centerline may be extracted in step 500 by tracking between the points on the skeleton.

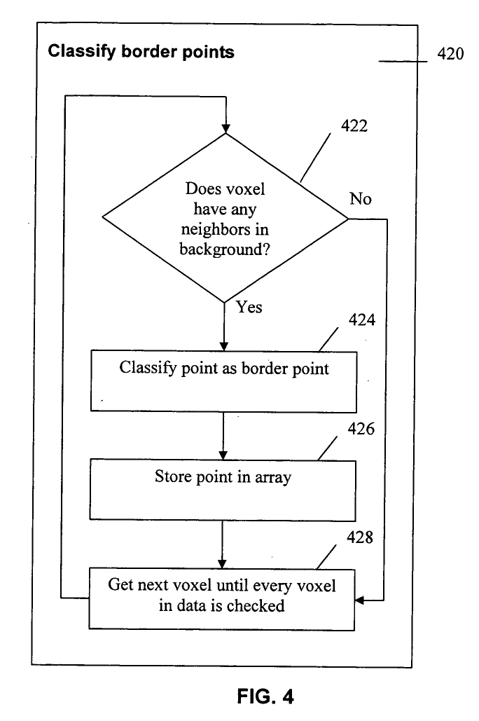

320 of centerline extraction 300 of FIG. 3 classifies the border points and stores them for processing. 320 is detailed further in FIG. 4. With reference thereto, in each iteration, every voxel in the segmented aneurysm data may be checked at 422. If the voxel has any neighbors in any of the 26 neighboring voxels, which are in the background (a background voxel may be defined as a voxel whose intensity falls outside the adaptive threshold range) it can be classified as a border point at 424 and can be stored in the respective arrays at 426. For a given voxel point A, the voxels within a 3×3×3 cube centered at A can be A's 26 neighbors. In exemplary embodiments of the present invention, border points can be classified into 26 different types, depending on which of its neighbors are background voxels, and the border points can be stored in their respective arrays for later processing.

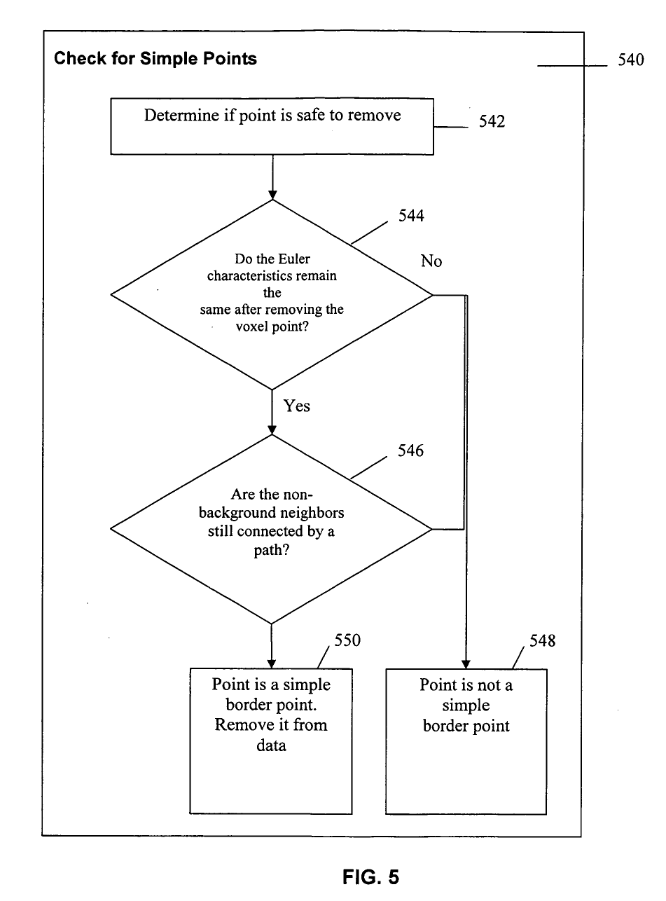

After the voxel points are classified at 420, simple border points may be determined at 440, as shown in FIGS. 3 and 5. A border point that is a “simple border point” may be removed from the data. 542 of FIG. 5 determines whether such a point may be removed. A simple border point is a border point that, if it is removed from the data, will not change its 26 neighbors connectivity in a topological manner. A border point can be topologically safe to remove if the conditions of both 544 and 546 are satisfied. Moreover, 544 determines whether the Euler characteristics for the 3×3×3 region remain the same after removing the voxel point A. For a given point, an Euler characteristic value will be calculated depending on point A and the configuration of its non-background neighbors according to an exemplary embodiment. If the value remains the same then removing the point will not affect the connectivity of its neighbors. If the conditions of step 544 are met, at 546 it can be can determined whether the non-background neighbors are still connected by a path within the 3×3×3-neighboring region after removing the border point. If this condition is met as well, the point may be classified as a simple border point at 550, and it may be removed from the data. If either of the conditions at 544 or 546 are not met, at 548 it can be determined that the point is not a simple border point, thus it is not removed from the dataset.

Turning again to FIG. 3, the next task of centerline extraction 300 after checking for simple border points is to perform a thinning operation at 360. The thinning operation may stop, in exemplary embodiments, when only a one-voxel point-width skeleton remains. In each iteration, the deletion of border points in the 26 directions may be carried out in a specific symmetric sequence. This can, for example, ensure the skeleton remains in the center of the vessel as precisely as possible. For example, the border points that may be classified in the “left” direction will be erased, then followed by erasing the border points in the “right” direction. The operation stops when only a one-voxel point-width skeleton remains.

In comparison with many typical methods that use a set of templates for simple point classification, the exemplary method described above generates a more accurate centerline skeleton. However, it may also be more prone to generating false branches in the centerline skeleton.

Continuing with reference to FIG. 3, operation 380 of centerline extraction 300 can be used to track specified vessels. After a skeleton is generated, using the three voxel-points from border point classification 320, a shortest connected path on the skeleton can be extracted out as the centerline. The skeleton that is generated from thinning operation 360 is preferably an unweighted graph in exemplary embodiments. Therefore, a standard breadth first search can determine the shortest connected path. This breadth first search algorithm can also be used for the centerline tracking.

In addition to the centerline extraction as illustrated in FIGS. 3-5 and described above, the following exemplary pseudocode can be used to implement centerline extraction in exemplary embodiments of the present invention.

Thinning:

```
Do
{
For each point in the volume
{
  if the point is a border point in 26 directions
  {
    store the point in the respective arrays (26 arrays)
  }
}
For each border point stored in the 26 arrays,
{
  If (IsSimpleBorderPoint(x, y, z))
  {
    remove the point from the array
    remove the point from the volume
  }
}
}while(there still are points removable)
Find the points on skeleton nearest to the 3 defined points:
Center_line_1 = Breadth_First_Search(skeleton, point1, point2);
Center_line_2 = Breadth_First_Search(skeleton, point1, point3);
```

The Breadth_First_Search performs a traversal through a series of connected voxels that touches all of the voxels reachable from a particular source voxel. In addition, the order of the traversal is such that the algorithm will explore all of the neighbors of a voxel before proceeding on to the neighbors of its neighbors. One way to think of breadth-first search is that it expands like a wave emanating from a stone dropped into a pool of water. Voxels in the same “wave” are the same distance from the source voxel. In this context, “distance” is defined as the number of voxels in the shortest path from the source voxel.

Turning again to FIG. 1, the next operation in centerline extraction 103 is smoothing 106. Smoothing 106 can be performed, for example, in order to remove small perturbations and false branches while maintaining the centerline property of the line. In some embodiments, smoothing 106 can, for example, perform Gaussian smoothing on initial centerline points in exemplary embodiments of the present invention. Gaussian smoothing preserves the initial centeredness of the centerline points better than other typical smoothing techniques. While other smoothing techniques can be used in place of Gaussian smoothing, most of them do not typically produce results that are as good as those achieved with Gaussian smoothing.

In an alternative exemplary embodiment of the present invention, McMaster's Slide Averaging may be used in place of Gaussian smoothing. This method takes the first point and its neighbors to compute an average position of the points and moves the first point to this new position. It then proceeds on to the second point and its neighbors to compute the average position of the new set points, and moves the second point to this new position, and repeats the process. Joining all these new average points can create the centerline.

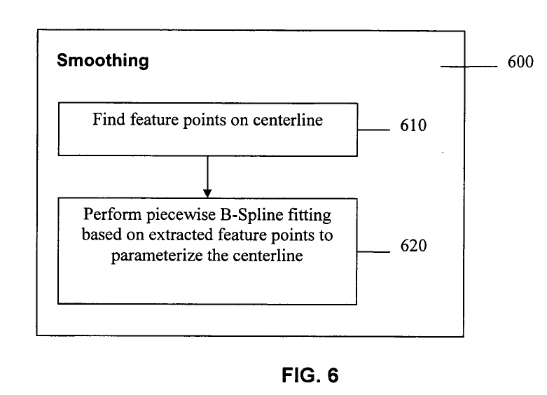

In an additional alternative exemplary embodiment, smoothing may be performed utilizing an exemplary smoothing process as illustrated in FIG. 6. With reference thereto, at 610 the alternative smoothing process finds feature points (where the curvature is relatively high) on the centerline. Next, at 620, a piecewise B-Spline fitting can, for example, be performed based on the extracted feature points to parameterize the centerline. Given two node points, normal B-Spline fitting can, for example, be used to link these two points. Two control points may be determined, and these control points are used to calculate the best fitting line joining the two node points by maintaining the continuity of the whole centerline.

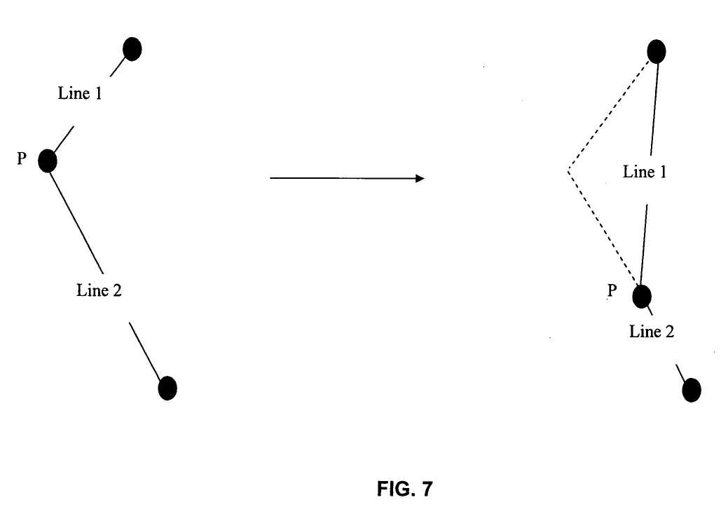

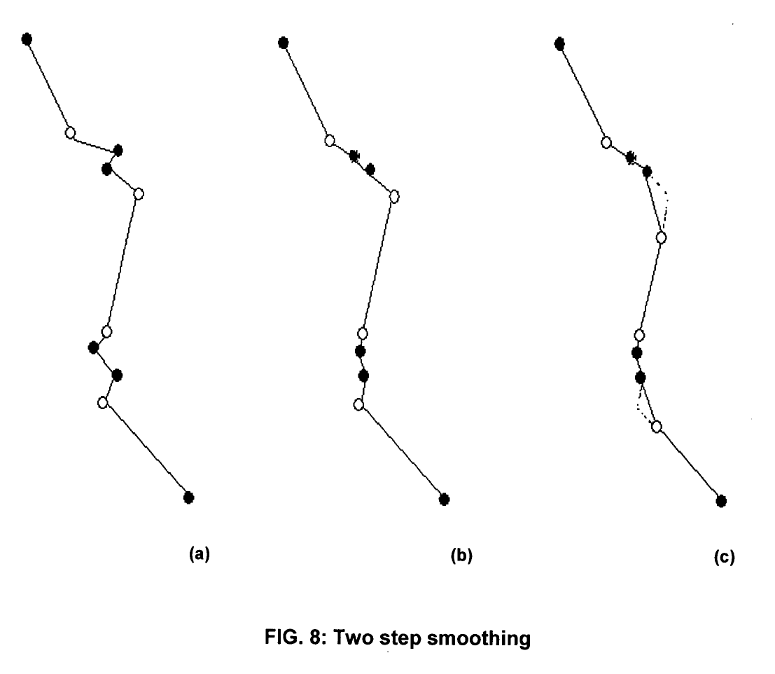

In alternative exemplary embodiments of the present invention, a two-step smoothing method (illustrated in FIGS. 7 and 8) can be used, for example, to remove noise instead of using the above-described technique. The former technique that uses piecewise B-Spline can produce a smoother centerline, but it may cause the centerline to be less accurate, especially for vessels, which are thin or have very high curvature. The alternative two-step smoothing method, described below and illustrated in FIGS. 7 and 8, can produce a centerline that is less smooth than the above-described method, but it can also, for example, preserve the centeredness property of the centerline. In exemplary embodiments of the present invention, accurate centerlines may be preferable in order to achieve accurate measurements for stent selection purposes for abdominal aortic aneurysms.

The two-step smoothing method classifies line nodes as three types based on the neighbors of the node: type 1 has neighbors on both sides along the centerline; type 2 has one-sided neighbors; and type 3 has no neighbors. In this method, the first step applies a low-pass filter on all type 1 points. In exemplary embodiments, this low-pass filter ultilizes weighted neighborhood averaging, where the new position of type 1 points is determined by the weighted average positions of its neighbors. The nearer neighbors can be given higher weights, while the neighbors further away can be given lower weights. After this step, some high frequency perturbations at type 1 points can be removed.

Next, the position of type 1 and type 2 points can be adjusted along the centerline to ensure that the angle between two connected line segments are larger than a given threshold in exemplary embodiments. This can, for example, be performed in order to avoid abrupt change in the direction of the line as well as to reduce the centerline deformation because of over-smoothing. Referring to FIG. 7, for example, if the angle between two connected line segments Line 1 and Line 2 is larger than a given threshold, the point P at the vertex of the angle can be moved along the long lateral (Line 2) with a step length equal to that of the short lateral (Line 1). This process can continue until the angle meets the requirement.

FIG. 8 illustrates how the line can be smoothed based on the two-step smoothing algorithm according to exemplary embodiments of the present invention. Line (a) is the initial line, where type 1 points are shown in red, while type 2 points are in yellow and type 3 points are shown in black. Line (b) of FIG. 8 illustrates how after the first step in the two-step smoothing method, the noise at type 1 (red) points can be removed. Line (c) of FIG. 8 illustrates the movement of type 1 points along the line to avoid abrupt direction change of the line. It is noted that both type 1 and type 2 points are candidates for this position adjustment. But in this example, only two type 2 points are moved according to the moving criterion.

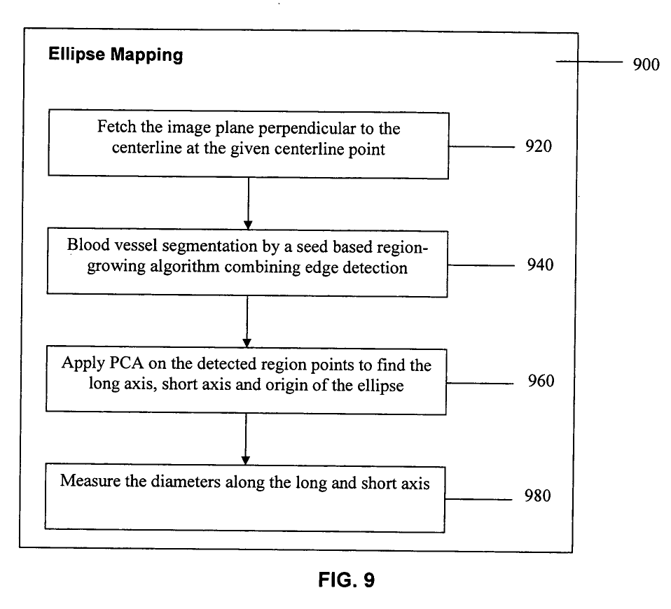

Upon completion of centerline extraction 103 of FIG. 1, automated measurements processing 200 can continue with ellipse mapping 107. The components of ellipse mapping are illustrated in FIG. 9. In exemplary embodiments of the present invention, ellipse mapping can be used to measure the diameter of blood vessels at a given position on an image plane perpendicular to the centerline. Ellipse mapping may be used, for example, to measure the maximum, minimum, and area of the blood vessel. Process 700 utilizes a point on the aneurysm centerline and the abdominal aortic aneurysm voxel data as inputs, and produces an ellipse whose long axis represents the maximum diameter and whose short axis represents the minimum diameter at the given position of the blood vessel.

As shown in FIG. 9, 920 extracts an image plane based on the segmented volume, which is centered at the given centerline point and is perpendicular to the centerline. Next, at 940, based on the centerline points, a seed based region growing algorithm combining edge detection can be performed on each 2D image plane to segment the blood vessel. In exemplary embodiments, Canny edge detection can be applied to locate the edges on the image plane, then use these edges as constraints for the region growing from the seed point (the centerline point). The Canny edge detection method performs optimal edge detection. First, it can smooth and eliminate image noise, find the edge strength by taking the gradient of the image, and obtain the edge directions. Next, in exemplary embodiments, a non-maximum suppression can used to trace along the edge in the edge direction and suppress any pixel value that is not considered to be an edge. Finally, heuristics can be used as a means of edge linking. After Canny edge detection, thin continuous edges can then be located.

If the edge does not enclose the seed point filly, however, the region growing will leak out to the surrounding areas. Thus, in exemplary embodiments, a stop criterion can be employed, for example, to avoid such leak outs. In exemplary embodiments, the average intensity of the edge points around the seed point can be used as a threshold. These edge points may be all located on a continuous edge line that is the nearest line to the seed point. The presence of calcium can sometimes cause false edges inside the blood vessel region. If the nearest edge is created because of calcium (because of its much higher average intensity compared to the seed point), it can be eliminated. In exemplary embodiments, the search of the nearest edge line will continue until the nearest high probability vessel edge is reached. This high probability vessel edge may have an average intensity that is very similar to the seed point.

In exemplary embodiments of the present invention, the following exemplary pseudocode for seed-based segmentation can be used:

```
For each image plane and its seed point (centerline point),
CannyEdgeDetection (srcImage, edgeImage);
Loop until the nearest high probability vessel edge around
seed point is reached
{
    FindNearestEdgeLine(seed, edgeImage, edgeLine);
    averageIntensity = ComputeAverageIntensity(edgeLine, srcImage);
    if((averageIntensity − seedIntensity)> CALCIUM_THRESHOLD)
      EliminateCalciumEdge (edgeImage, edgeLine);
  Else
      Break;
}
regionGrowThreshold = averageIntensity;
segmentedRegion = SeedBasedRegionGrowing (seed, srcImage, edgeLine,
regionGrowThreshold);
```

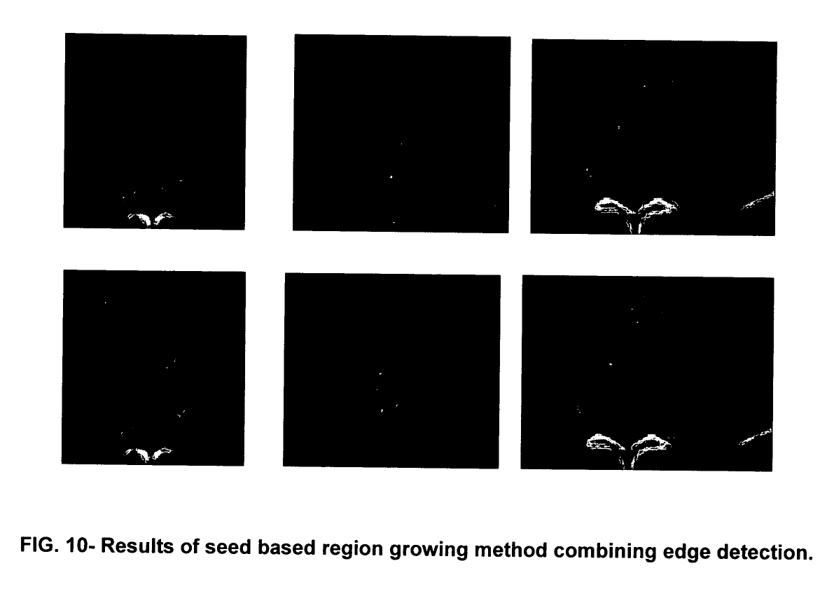

In the pseudocode, CannyEdgeDetection may generate an edge image (edgeImage), which is a binary image from the original image (srcImage). FindNearestEdgeLine may detect the nearest continuous edge line (edgeLine) around the seed point based on the edge image generated by CannyEdgeDetection. ComputeAverageIntensity computes the average intensity of the edge points on the nearest edge line around the seed point, and SeedBasedRegionGrowing segments the blood vessel region based on the edge image and the stop criterion (the intensity threshold—regionGrowThreshold). FIG. 10 illustrates some results of this segmentation algorithm.

Turning again to FIG. 9, process 960 of ellipse mapping 107 can apply, for example, Principle Components Analysis (PCA) on region points to find the long axis, short axis and origin of the ellipse in exemplary embodiments. PCA is a mathematical method that transforms a number of possibly correlated variables into a smaller number of uncorrelated variables called principal components. The first principal component (which includes the eigenvector and eigenvalue) accounts for as much of the variability in the data as possible, and each succeeding component accounts for as much of the remaining variability as possible. Thus, after PCA transformation, along the derived eigenvectors, the sample variances are extremes (maxima and minima), and uncorrelated.

In exemplary embodiments, the nature of PCA may be used to achieve ellipse mapping. The positions of blood vessel region points are collected as the input of PCA. After decomposition of the covariance matrix of the points' positions, the first eigenvector points to the direction where the variance of points distribution is maximal, while the second eigenvector points to the direction where the variance of points distribution is minimal. Thus, the first eigenvector implies where to measure the maximum diameter, and the second eigenvector implies where to measure the minimum diameter. In exemplary embodiments, the first and second eigenvectors may be used as the long axis and short axis directions of the ellipse and use the average position as the origin of the ellipse.

The typical method of ellipse mapping is to fit a parameterized ellipse model to the blood vessel region and minimize the fitting error. In image processing, PCA is usually used to reduce the dimension of features (multi-variance), and is seldom used for ellipse mapping. However, based on the mathematics behind it, this method can provide optimal directions along which the features are mainly distributed. PCA, as described in the exemplary embodiments above, provides the directions along which, the most or the least of the blood vessel edge points lie. These are the ellipse axis directions.

There may be several advantage to using PCA for ellipse mapping in exemplary embodiments. First, PCA provides optimal directions of the points' distribution. Furthermore, because of the statistical nature of PCA, it can avoid noise disturbances. In addition, there is a low computational cost in using PCA for ellipse mapping. The computational complexity of PCA is O(n), where n is the number of the edge points.

Turning to 980 of FIG. 9, the diameters along the long and short axes can be measured. In exemplary embodiments, the edge points may be grouped along the axis into two sides of the origin, and measure the shortest distance between the two groups as the diameter.

In exemplary embodiments of the present invention, the following exemplary pseudocode for ellipse mapping (as described above in connection with FIG. 1, 107 and FIG. 9) may be used:

```
SegmentBloodVesselRegion (seed, image, resRegion);
ComputeConvarianceMatrix (resRegion, covariance);
Decomposition (covariance, eigenvectors, eigenvalues);
ellipseOrigin = LocateEllipseOrigin (eigenVectors);
For each eigenvector,
{
  FindEdgePointsOnTwoSides (edgePointsOnLeftSide,
  edgePointsOnRightSide);
  diameter = FindShortestDistance( );
}
```

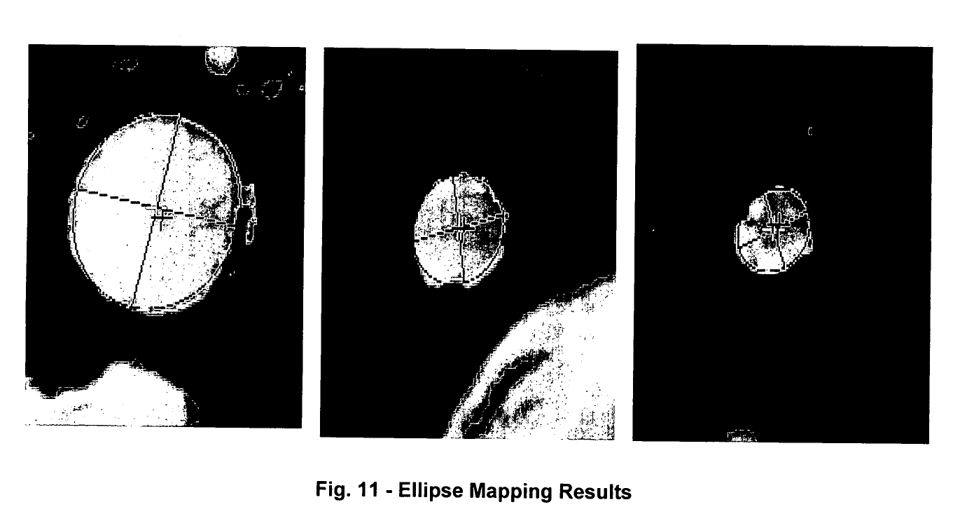

SegmentBloodVesselRegion may use the seed-based region growing method of the exemplary embodiment described. The region points are stored in resRegion, and ComputeConvarianceMatrix may compute the covariance matrix of the points' positions inside the segmented region. Decomposition may compute the two eigenvectors and eigenvalues of the covariance matrix. EdgePointsOnTwoSides finds the edge points along the eigenvectors and group them into two sides (edgePointsOnLeftSide, edgePointsOnRightSide). FIG. 11 illustrates exemplary ellipse mapping results.

Turning again to FIG. 1, 108 relates to template mapping. In exemplary embodiments of the present invention, this method maps the measuring template onto an aneurysm volume to ensure that all necessary measurements for stent planning can be made. One advantage of this automated mapping process is that can reduce the tedious work of manual measurement. In addition, a best-fit stent can be automatically selected from a database in exemplary embodiments. Processing at 108 utilizes smoothed centerline and segmented aneurysm volume to produce automated measurements (e.g., diameters, lengths, angles, and volumes) that are necessary for stent planning and selection.

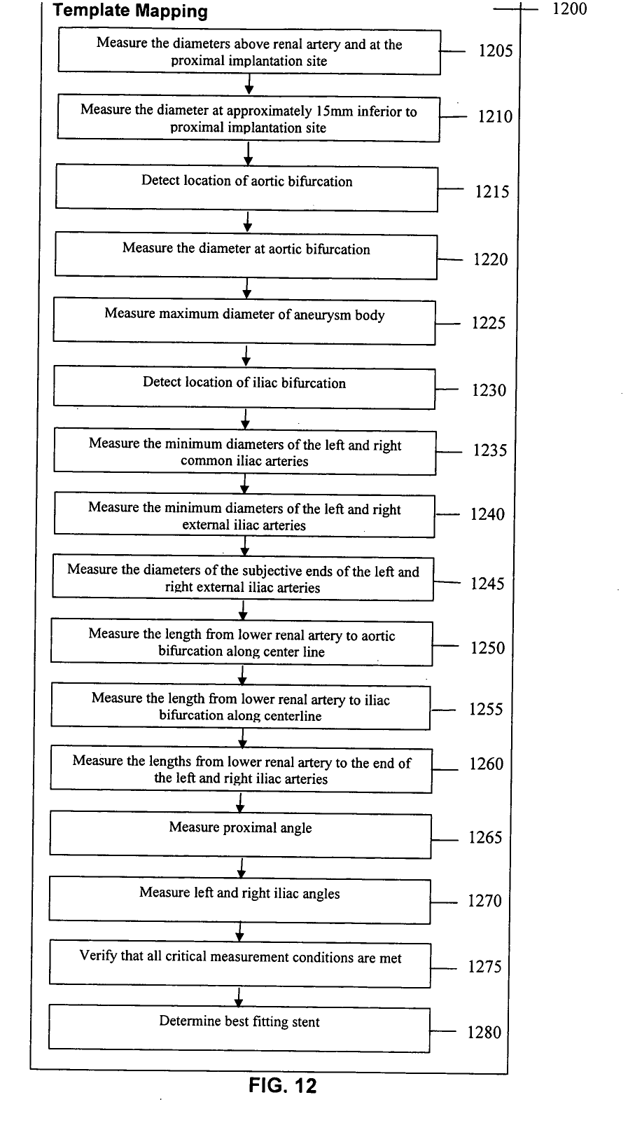

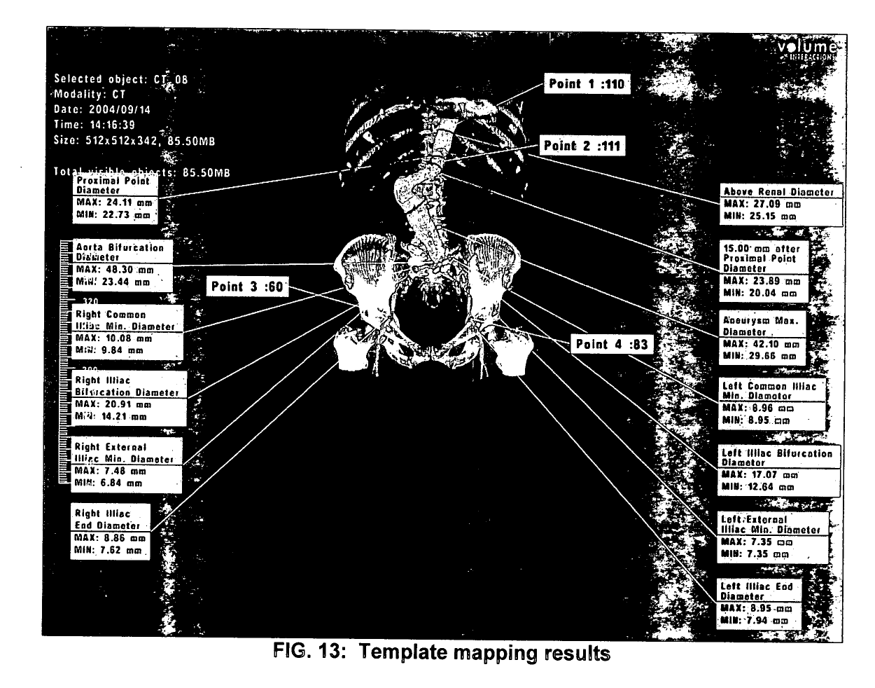

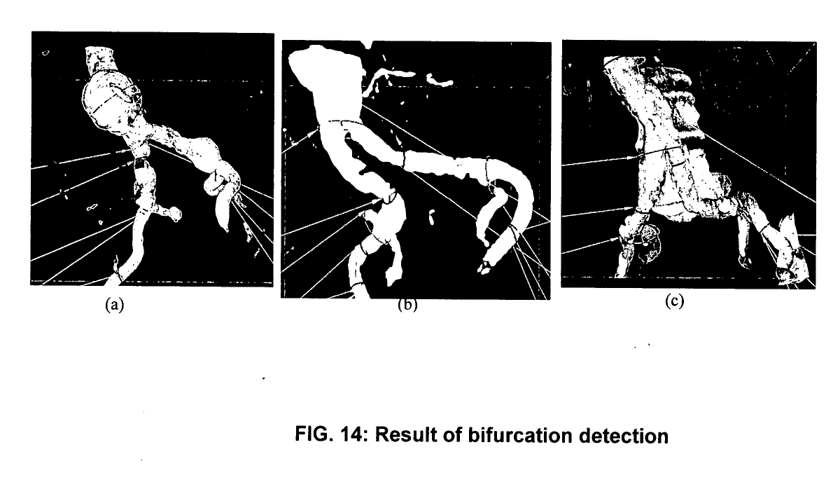

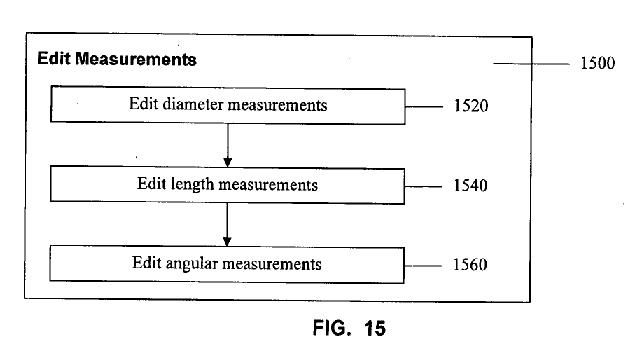

FIG. 12 illustrates an exemplary method for template mapping. 1205 of template mapping 1200 measures the diameter above the renal artery (the first user-defined point) and the diameter at the proximal implantation site (the second user-defined point), and 1210 determines the diameter at 15 mm inferior to the proximal implantation site (the distance is measured along the centerline). Next, at 1215 and 1220, the aortic bifurcation may be detected and the diameter at the aortic bifurcation (distal neck diameter) may be measured. In some exemplary embodiments, the location of aortic bifurcation can be automatically detected. Automatic detection may be based upon several observations. For example, after ellipse mapping, the origin of the ellipse may not coincide with the corresponding centerline node. But the more the mapping region is circle-like, the smaller the distance between the ellipse origin and the centerline node. Another consideration for automatic detection is whether the region to be mapped near the bifurcation is less similar to a circle than elsewhere along the aorta. A further consideration is whether the region near the bifurcation is shaped like an “8”, as if it were formed by two connecting circular branches. If the connection between the two circular branches is very thin (such as, for example, 1 or 2 pixels), ellipse mapping can detect edge points inside the region. Thus, the derived ellipse diameter is close to the diameter of the bigger branch, and the derived ellipse origin is close to the centerline node for the bigger branch. In this case, if the search continues along the smaller branch centerline, the corresponding centerline node can be found outside the derived ellipse. A simple morphological opening operation before ellipse mapping can avoid this problem by separating the weakly connected branches. In exemplary embodiments, two criteria may be utilized in order to locate an anatomic bifurcation. First, the deviation from the ellipse origin to the centerline point is relatively large, and second, the diameters near the anatomic bifurcation changes suddenly. This automatic aortic bifurcation detection may occur at step 1215 in exemplary embodiments of the present invention.

In exemplary embodiments of the present invention the following pseudocode for aortic bifurcation detection can be used:

```
For each centerline node inferior to centerline bifurcation and superior
to centerline end
{
    EllipseMapping (centerline_node, centerline_node_tangent);
    If centerline_node is outside of the ellipse,
    {
        Opening (mapping_slice);
        EllipseMapping (centerline_node, centerline_node_tangent);
    }
  if (Distance(ellipse_origin, centerline_node) > average_distance *
THREHOLD_RATIO1) and (nextDiameter < diameter *
THRESHOLD_RATIO2)
  {
      bifurcation_location = centerline_node;
      break;
  }
}
```

In the exemplary pseudocode provided above, centerline_node refers to the points on the centerline, and centerline_node_tangent refers to the tangent direction at the centerline_node. The average_distance can be computed as the standard deviation of distances from the ellipse origin to the centerline node along each iliac centerline. THREHOLD_RATIO1 and THREHOLD_RATIO2 can domain specific values. For example, THREHOLD_RATIO1 may be set as 3.0 and THREHOLD_RATIO2 as ⅔ as preferable ratios for abdominal aortic aneurysm data. THRESHOLD_RATIO1 represents the ratio of the distance of the ellipse origin from the centerline node, and THRESHOLD_RATIO2 represents the rate of consecutive diameter change along the centerline.

In exemplary embodiments of the present invention, the location of iliac bifurcations can be automatically detected as well at 1230 of FIG. 12. The detection of the iliac bifurcations is different from the detection of the aorta bifurcation for at least two reasons. Firstly, to detect the aorta bifurcation, two centerlines (of the left and the right iliac arteries respectively) can be utilized. However, following the iliac bifurcation only the centerline of the external iliac artery is extracted. Secondly, there is possibly aneurysm on the iliac arteries as well. Therefore, the second assumption of an aorta bifurcation—the diameters near the anatomic bifurcation changes suddenly—can no longer be used to identify an iliac bifurcation. For example, the end of an iliac aneurysm can also meet that condition. Hence the criteria for locating an iliac bifurcation are modified as: first, the deviation from the ellipse origin to the centerline point deceases suddenly after the bifurcation, and second, the bifurcation is not circular. The first criterion excludes the possibility of an aneurysm. The second criterion helps to remove the noise from the process of centerline extraction. When the error from centerline extraction is salient, the deviation can be big on non-bifurcation parts. However, the cross-section on non-bifurcation parts usually approximates a circle more than that of the bifurcation part. Hence, the noise from centerline extraction can be filtered by examining the circularity of a cross-section. Before applying the criteria on iliac arteries, a noise-filtering step is a must to remove the noise generated from ellipse mapping.

In exemplary embodiments of the present invention exemplary pseudocode for iliac bifurcation detection can be the following:

```
For each centerline node inferior to aorta anatomic bifurcation and
superior to the subjective end of external iliac artery
{
  EllipseMapping(centerline_node, centerline_node_tangent);
  Compute_Deviation_From_Centerline_Node( );
  Compute_NotCircular_Degree( );
}
Filtering_Noise_From_EllipseMapping (ellipses);
maxDeviation = 0;
For each ellipse,
{
  if((currentDeviation < THRESHOLD1 * prevDeviation
    and (currentDeviation > meanDeviation)
    and (currentDiameter < prevDiameter)
    and (currentNotCircularDegree > THRESHOLD2)
    and (currentDeviation > maxDeviation) )
  {
    maxDeviation = currentDeviation;
    possible_bifurcation_location = prev_centerline_node;
  }
}
bifurcation_location = possible_bifurcation_location;
```

In the exemplary pseudocode provided above, centerline_node refers to the points on the centerline, and centerline_node_tangent refers to the tangent direction at the centerline_node. Compute_Deviation_From_Centerline_Node( ) is to compute the standard deviation of distances from the ellipse origin to the centerline node along each iliac centerline.

Compute_NotCircular_Degree( ) is to compute the ratio of long axis over short axis for each ellipse. The bigger the degree, the smaller the circularity is.

Filtering_Noise_From_EllipseMapping( ) is a function to filter those salient errors generated by ellipse mapping. THREHOLD1 and THREHOLD2 are domain specific value. For example, THREHOLD1 can be set, for example, as ⅔ and THREHOLD2 can be set, for example, as 1.2.

At 1225 of FIG. 12, the maximum diameter of the aneurysm body may be measured. In exemplary embodiments, this diameter measurement can be made from a point approximately 15 mm inferior to the proximal implantation site to the aortic bifurcation Next, the minimum diameters of the left and right common iliac arteries and the external iliac arteries may be measured at 1235 and 1240 of FIG. 12. At 1245, the diameters of the ends of left and right external iliac arteries (the second and third points defined by the user) can be measured. The length from lower renal artery to aortic bifurcation along centerline can, for example, be measured at 1250. Next, the lengths from lower renal artery to the bifurcation of left and right common iliac arteries can be measured at 1255. The lengths from lower renal artery to the end of left and right iliac arteries may be measured at 1260. The proximal neck angle can be measured at 1265, and the left and right iliac angles can be measured at 1270 in exemplary embodiments of the present invention.

Upon completion of these exemplary measurements, at 1275 it can be verified that all of the measurement conditions specified in the critical notes are met. If any of the measurements did not pass the conditional test, visual feedback and notification can be provided to the user. Finally, at 1280, a best fitting stent can be determined from a stent database based upon the above measurements. In exemplary embodiments of the present invention, a user is able to set the fitting tolerances. A best fitting stent is one that matches the automated measurements as closely as possible and has a fitting tolerance that is not more than what is specified by the user. If no available stent meets the requirement, a measurement report will be generated which can then be used as a basis to manufacture a customized stent.

Edit Measurements

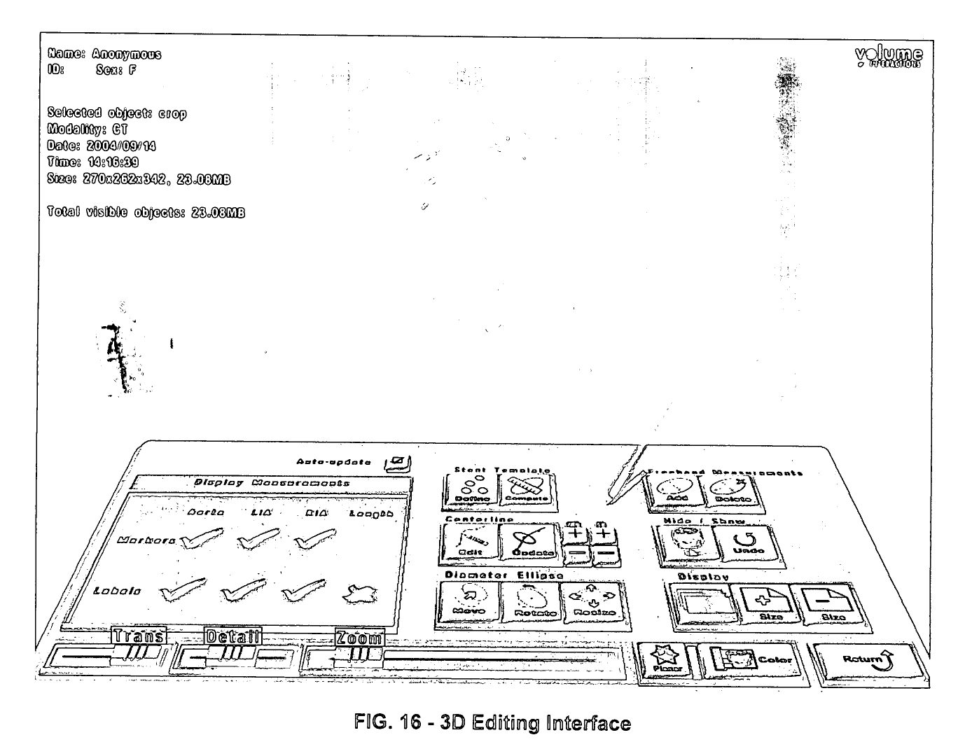

Turning to FIG. 1, in exemplary embodiments edit measurements at 109 can be performed, which is detailed further in FIG. 15. In exemplary embodiments, the diameter measurements may be edited at 1520, thus enabling the refinement of measurements in a 3D environment. Such an exemplary 3D environment, as illustrated in FIG. 16, may allow users to have greater freedom to edit abdominal aortic aneurysm measurements than in similar 2D environments. In exemplary embodiments, the 3D environment may utilize a stereoscopic or autostereoscopic display system. By utilizing the diameter, length, and angular measurements, modified measurements may be produced by moving, resizing, rotating the rendered image of the abdominal aortic aneurysm.

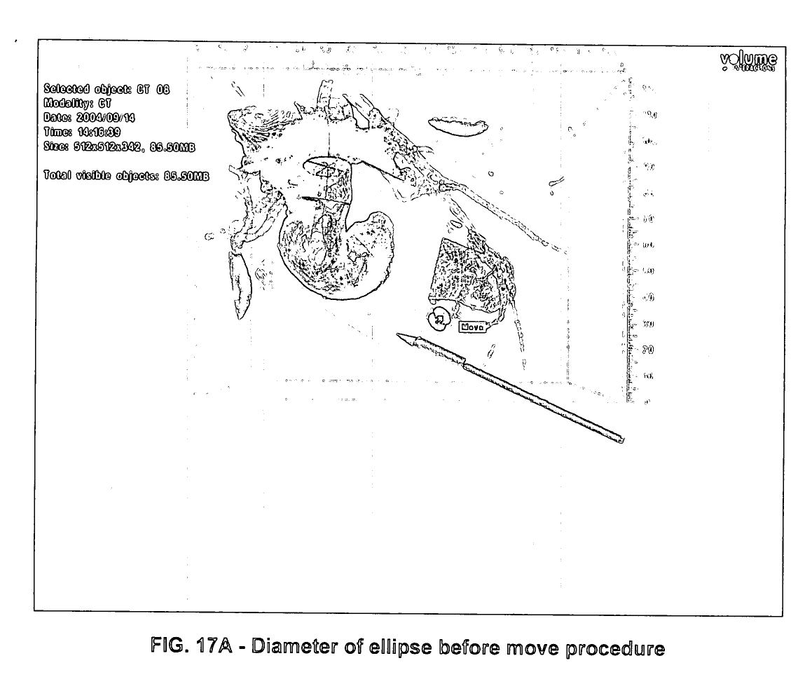

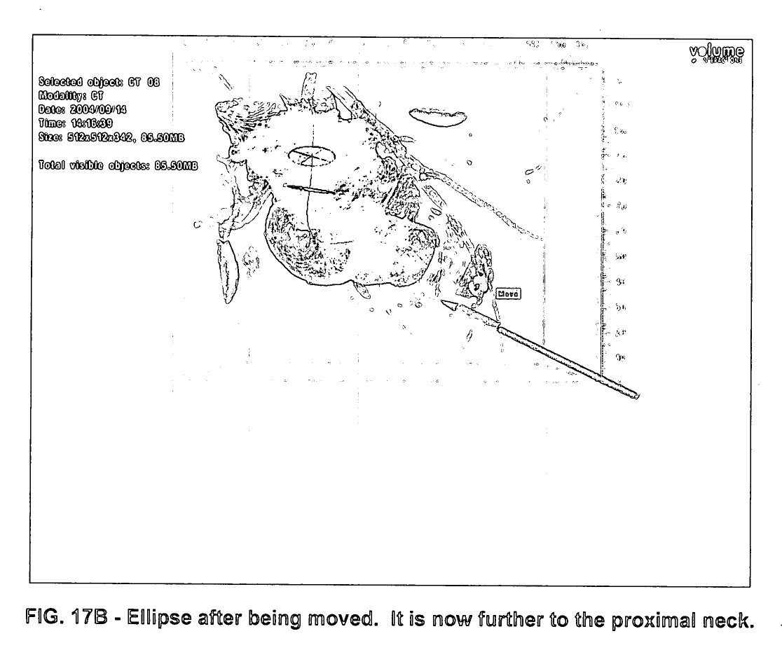

During and exemplary editing process, the slice for the measurement is displayed at the measurement location. The user may edit the diameter measurements. In a move operation, the user may move diameter measurements along centreline. FIG. 17A illustrates the diameter of an ellipse prior to a move operation, and FIG. 17B depicts the diameter of the ellipse after a move procedure, where the ellipse is farer to the proximal neck. Once the new position is decided, an automatic calculation (i.e., ellipse mapping) may be performed to form a new measurement. The movement of a diameter measurement may be limited in the range between the two diameter measurements superior and inferior to it along the centreline.

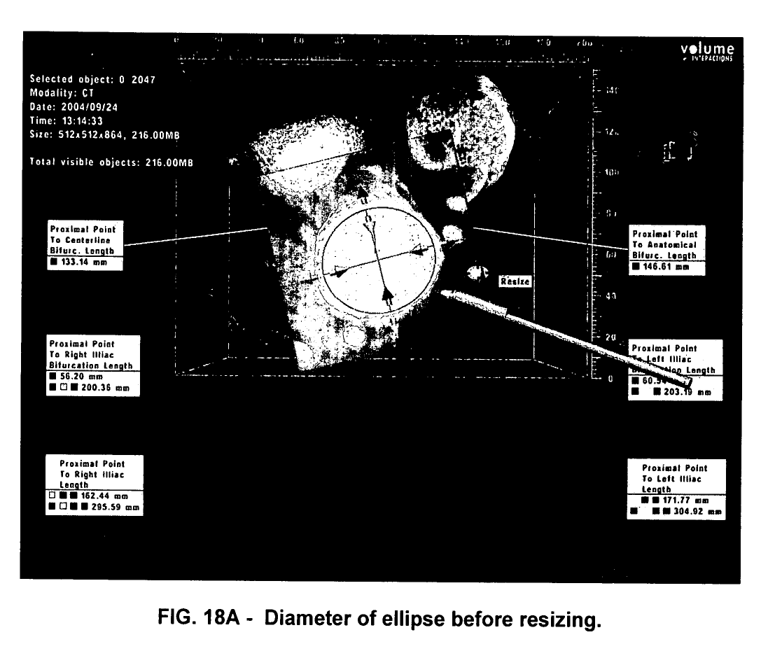

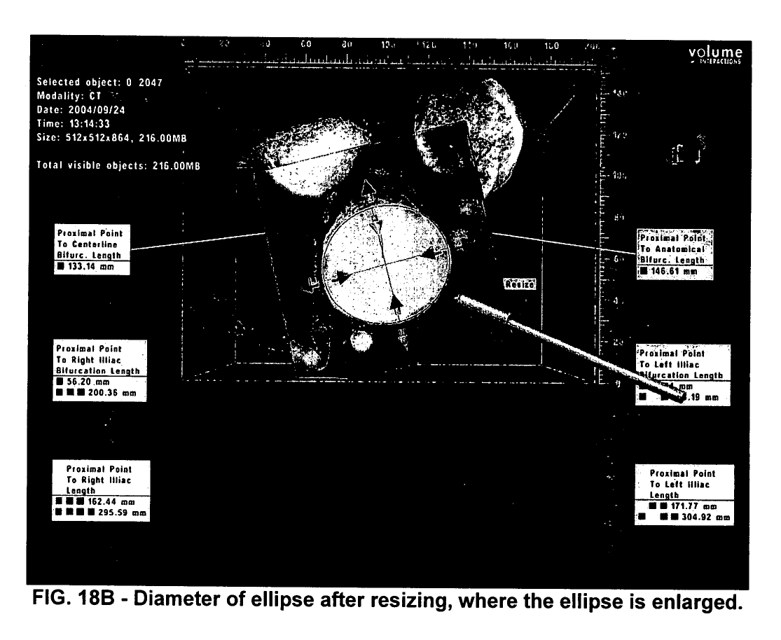

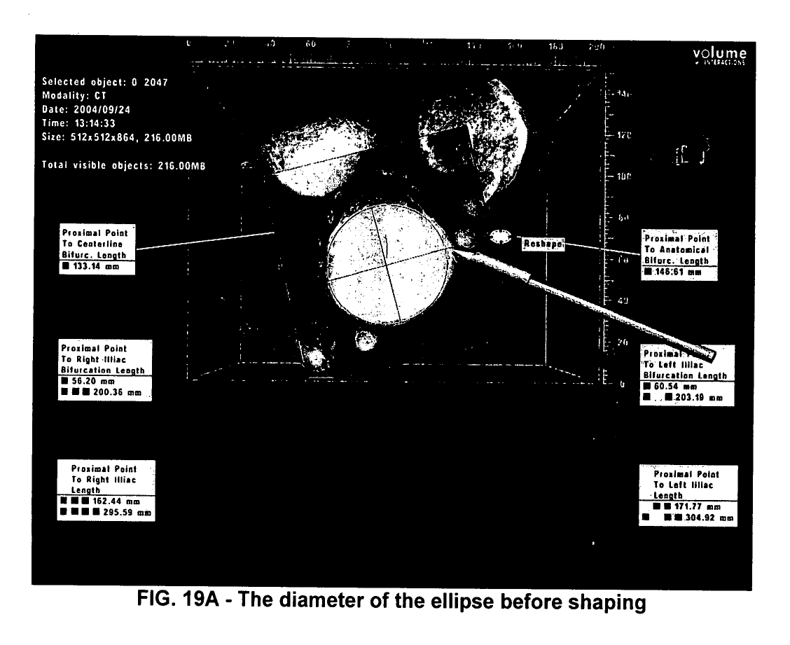

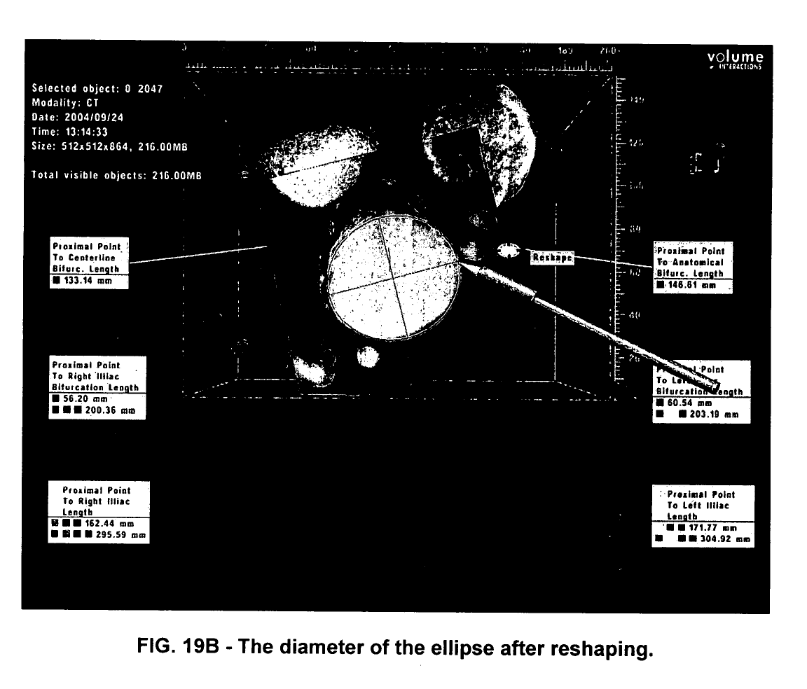

If a user wishes to perform a resize operation in the 3D environment, the size and the shape of the diameter of the ellipse may change. In order to change the shape of the ellipse, a user may select the axes of the ellipse and drag the axes to the desired place. To change the size of the ellipse, a user may select a position anywhere on the ellipse, except on or near the axes. FIG. 18A depicts the diameter of the ellipse prior to a resize operation. Turing to FIG. 18B, the ellipse is shown after resizing, where it is enlarged. In exemplary embodiments, the ellipse may also be reshaped. FIG. 19A illustrates the diameter of an ellipse before reshaping, and FIG. 19B depicts the diameter after reshaping. In FIG. 19B, the dragging point on the long axis can be placed in a new position, and the ellipse may be recomputed.

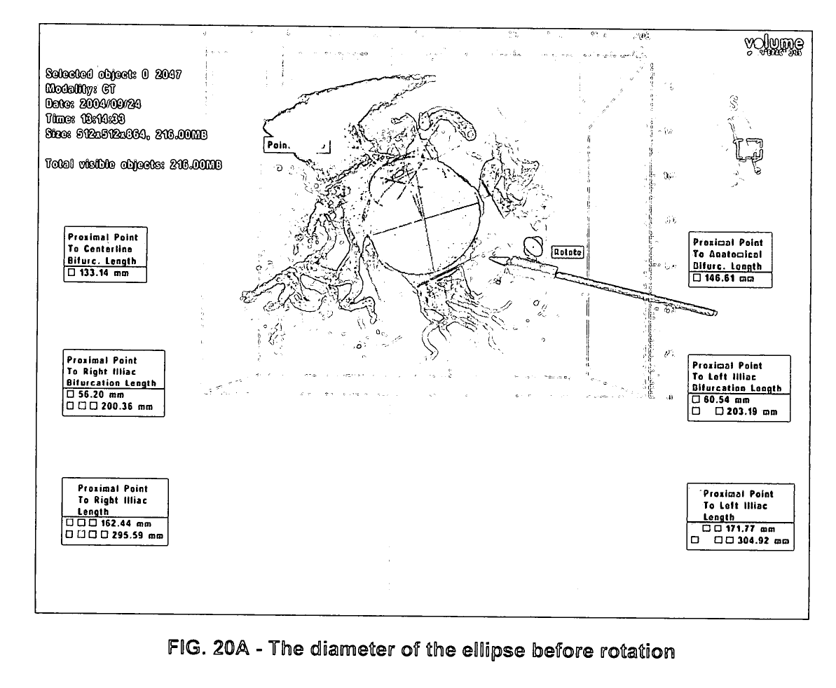

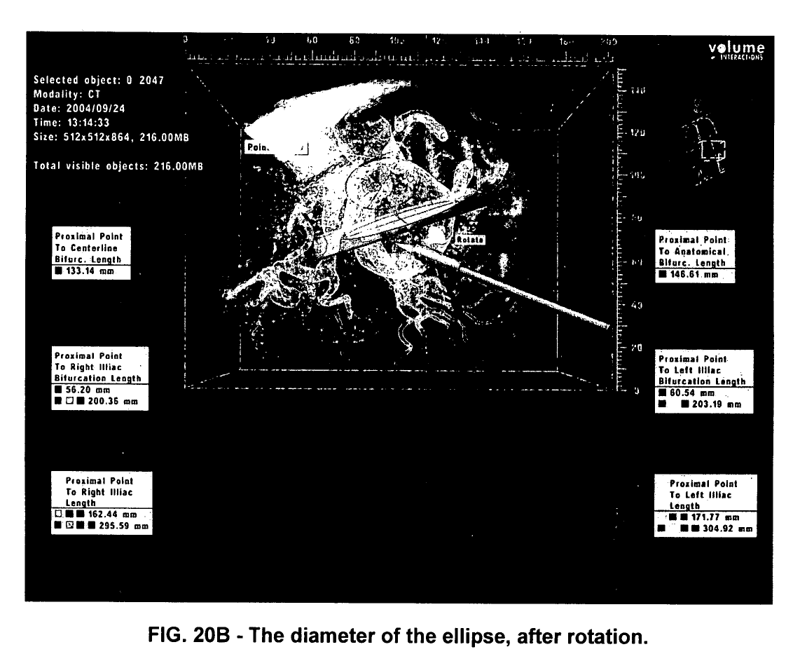

In addition, a user may perform a rotate operation in the 3D environment, which allows a user to rotate the diameter ellipse around the corresponding centerline by free hand movement (e.g., manual movement of the image in an exemplary system). FIG. 20A illustrates the ellipse prior to a rotation operation, while FIG. 20B depicts the ellipse after a rotation operation, where the orientation of the ellipse is adjusted. Upon adjustment of the orientation, an automatic calculation (i.e., ellipse mapping) is performed to form a new measurement.

Returning to FIG. 15, while the diameter measurements may be edited as described above, the length measurements may be correspondingly be edited at 1540. Generally, it is not necessary for a user to directly edit length measurements. Once the diameter ellipses at the proximal implantation site, at the aortic bifurcation, or at the end of left and right iliac arteries are moved, the corresponding length measurements may be automatic re-computed.

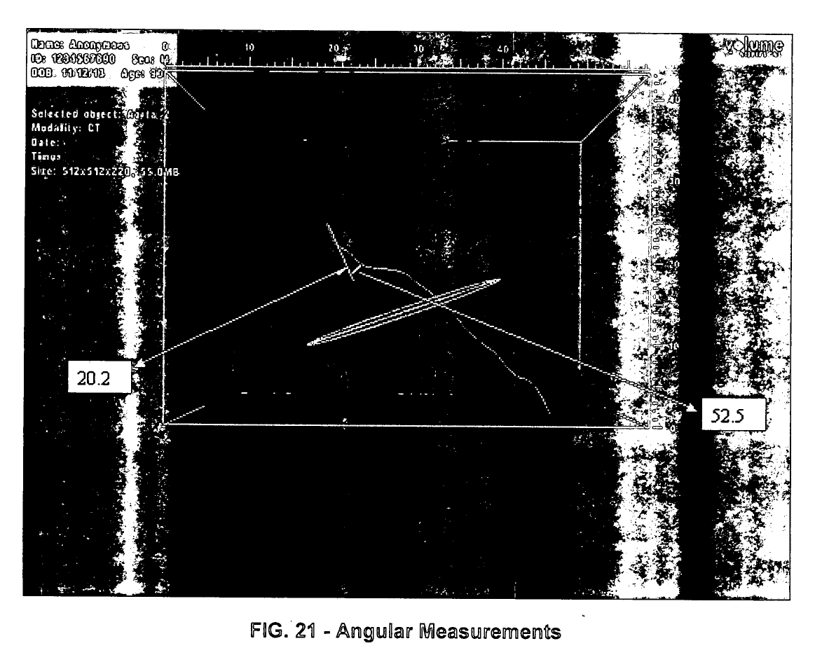

In addition to editing the diameter and length measurements, the angular measurements may be edited as well at 1560 of FIG. 15. In an exemplary embodiment of the invention, users may modify angular measurements by selecting and dragging either the laterals of the angle, as is illustrated in FIG. 21.

Validate Measurements

Turning again to FIG. 1, the final processing operation is to validate measurements 110, which can be used to verify that the diameter, length and angle measurements that have been made in the previous steps are accurate.

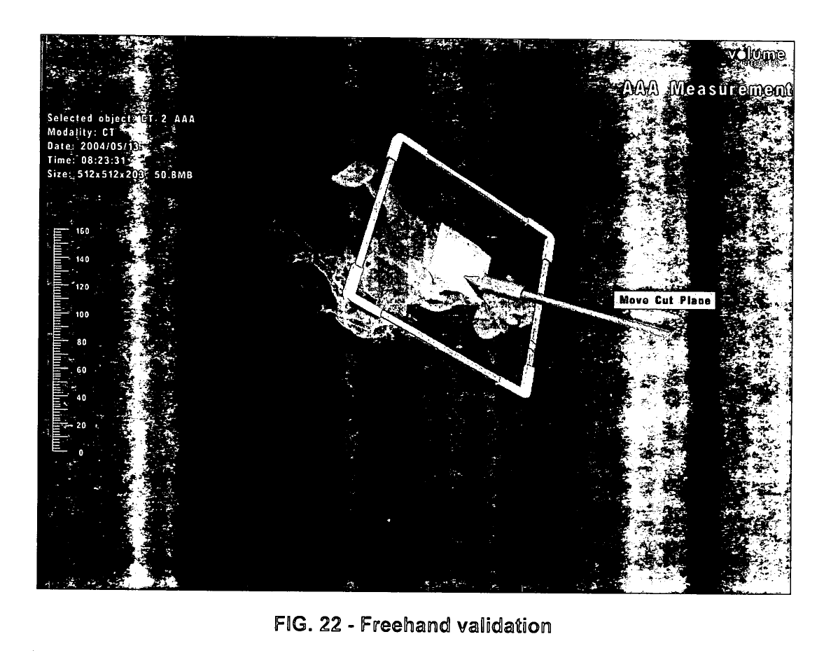

Several methods may be used in order to validate the measurement results. In one exemplary embodiment, freehand validation may be used. In this mode, users can place a cutting plane at any position of the blood vessel in any orientation. As illustrated in FIG. 22, a corresponding cropped slice with original data intensity is shown at the center of the cutting plane. Thus, users can check how the measurements fit against the original data.

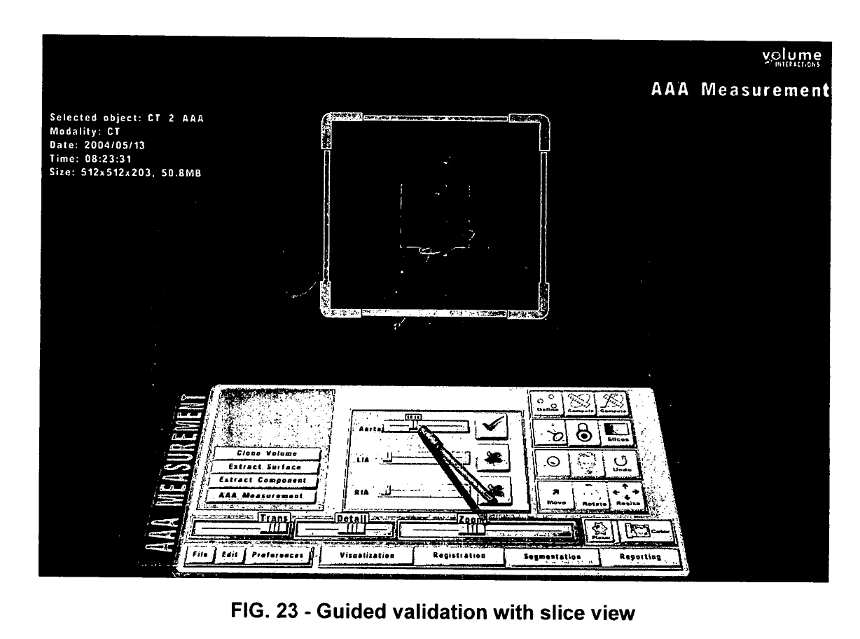

In another exemplary embodiment, guided validation with slice view may be used to verify the measurements. In this mode, as depicted in FIG. 23, validation is guided by the centerline. For this purpose, three slider bars are used for aneurysm body, left iliac artery and right iliac artery respectively. As the user moves the slider bar, a cutting plane, which is centered at the centerline points and remains perpendicular to the centerline, is automatically moved through the centerline. The original slices at the centerline positions are shown at the center of the cutting plane. During the validation process, the cutting plane always faces users to achieve the optimal viewing angle.

In yet another exemplary embodiment, guided validation with “fly-through” (blood vessel “fly-through” with measurements) may be used to verify the measurements. In this mode, users can view the vessel and measurements from the inside of the aorta. The path is governed by the centerline. Hence, users can validate the measurements from inside the blood vessel. This mode gives the user an added assurance of the topology and geometry of the aneurysm from inside the aorta.

Exemplary System

In exemplary embodiments according to the present invention, any 3D data set display system can be used. For example, the Dextroscope™, provided by Volume Interactions Pte Ltd of Singapore is an excellent platform for exemplary embodiments of the present invention. The functionalities described can be implemented, for example, in hardware, software or any combination thereof.

The present invention has been described in connection with exemplary embodiments and implementations, as examples only. Thus, any functionality described in connection with an abdominal aortic aneurysm can just as well be applied to any organ or luminal structure, such as, for example, a large blood vessel or, for example the heart or liver, it being understood that mapping of a knowledge structure to an organ will involve different signature structures depending upon the organ under study. It is understood by those having ordinary skill in the pertinent arts that modifications to any of the exemplary embodiments or implementations, can be easily made without materially departing from the scope or spirit of the present invention.

What is claimed:

1. A method for measuring tube-like organs using knowledge structure mapping, comprising:
defining a knowledge structure template;
performing centerline extraction;
performing ellipse mapping; and
performing template mapping.

2. The method of claim 1, further comprising editing measurements and validating the measurements.

3. The method of claim 1, wherein the centerline extraction further comprises:
classifying border points and storing them for processing;
checking the border points for simple border points;
performing a thinning operation; and
tracking a specified tube-like organ.

4. The method of claim 3, wherein the classifying border points further comprises determining if voxels have any neighbors in a background.

5. The method of claim 3, wherein the checking for simple points further comprises determining if the voxel point is safe to remove.

6. The method of claim 5, wherein the determining if the point is safe to remove comprises:
determining if the Euler characteristics of the point remain the same after removing the voxel point; and
determining if the non-background point neighbors connected by a path.

7. The method of claim 1, further comprising performing a smoothing of the centerline.

8. The method of claim 7, wherein the smoothing of the centerline is Gaussian smoothing.

9. The method of claim 7, wherein the smoothing comprises:
finding feature points on the centerline; and
performing piecewise B-Spline fitting based on extracted feature points to parameterize the centerline.

10. The method of claim 7, wherein the smoothing comprises:
classifying centerline points into types;
applying a low-pass filter to a first type of node; and
adjusting the position of the first type and a second type of point along the centerline.

11. The method of claim 1, wherein the ellipse mapping further comprises:
extracting an image plane based on a segmented volume;
utilizing a seed-based region growing technique with edge detection on each image plane of the segmented volume;
applying principle components analysis on region points to find the long axis, short axis, and origin of the ellipse; and
measuring the diameters along the long and short axis.

12. The method of claim 1, wherein the template mapping further comprises:
measuring a diameter at a proximal implantation site;
measuring a diameter 15 mm inferior to the proximal implantation site;
measure the diameter at an aortic bifurcation;
measuring the maximum diameter of an aneurysm body, wherein the measurement is made from a point 15 mm inferior to the proximal implantation site to the aortic bifurcation;
measuring the diameters of the ends of left and right external iliac arteries;
measuring the minimum diameters of the left and right iliac arteries inferior to the aortic bifurcation, and superior to the ends of the iliac arteries;
measuring the length from lower renal artery to the aortic bifurcation along the centerline;
measuring the lengths from the lower renal artery to the end of the left and right iliac arteries;
measuring the proximal neck angle; and
measuring the left and right iliac arteries.

13. The method of claim 12, wherein the aortic bifurcation is automatically detected.

14. The method of claim 12, further comprising verifying that all measurement conditions in the knowledge structure template are met.

15. The method of claim 14, further comprising determining a best fitting stent from a stent database.

16. The method of claim 1, wherein editing measurements further comprises moving the diameter measurements along a centerline and automatically remapping the ellipse.

17. The method of claim 1, wherein editing measurements further comprises changing the size and shape of the diameter of the ellipse.

18. The method of claim 1, wherein editing measurements further comprises rotating the diameter ellipse around the centerline.

19. The method of claim 1, wherein editing measurements further comprises editing the length measurements of the ellipse.

20. The method of claim 1, wherein editing measurements further comprises editing the angular measurements.

21. The method of claim 1, wherein the validating the measurements further comprises freehand validation.

22. The method of claim 1, wherein the validating the measurements further comprises guided validation with slices view.

23. The method of claim 1, wherein the validating the measurements further comprises guided validation with fly-through.

24. A method for mapping a defined knowledge structure to organ data, comprising:
defining a knowledge structure template comprising an anatomical signature of the organ;
performing extraction of key signature features;
performing mapping of geometric structures; and
performing template mapping.

25. The method of claim 24, wherein the organ is a tube-like structure.

26. The method of claim 25, wherein said key signature features include the centerlines of one or more tube-like structures.

27. The method of claim 25, wherein said geometric structures are elliptical structures corresponding to cross sections of the inner or outer lumen of said one or more tube-like structures.

28. The method of claim 24, wherein the organ is the heart.

29. The method of claim 28, wherein the key signature features include geometric and spatial parameters of the left and right ventricles veins and arteries.

30. The method of claim 29, wherein said indicia include centerlines of the veins and arteries.
